(19) United States
(12) Patent Application Publication
(10) Pub. No.: US 2013/0272647 A1
(43) Pub. Date: Oct. 17, 2013

(54) OPTICAL COUPLING DEVICE, OPTICALSYSTEM AND METHODS OF ASSEMBLY

(71) Applicant: Gert Droesbeke, Geel (BE)

(72) Inventor: Gert Droesbeke, Geel (BE)

(73) Assignee: FCI, Guyancourt (FR)

(21) Appl. No.: 13/822,329

(22) PCT Filed: Sep. 5, 2011
(86) PCT No.: PCT/IB11/02455

§ 371 Date: Mar. 12, 2013

(30) Foreign Application Priority Data
Sep. 14, 2010 (IB) PCT/IB10/02792

(51) Int. Cl. G02B 6/26

(52) U.S. Cl. CPC G02B 6/262
USPC 385/14; 385/39; 156/60; 156/64

(57) ABSTRACT

An optical coupling device comprises: a Z-reference part co-operating with a Z-reference of a first optical device, to define the location of a first optical interface of the coupling device along a direction (Z), fixation parts (17, 19), extending at different heights along this direction, adapted to be glued to the first optical device.

### FIELD OF THE INVENTION

The instant invention relates to optical coupling devices, optical systems and methods of assembly.

### BACKGROUND OF THE INVENTION

Most communication systems involve a number of system-cards. Such cards are usually manufactured as so-called printed circuit boards (PCBs). Because of the ever increasing requirements in data rates, due for example to the Internet, the limits of using electrical communications are being reached. It has become difficult to guarantee good signal integrity over the electrical lines.

To respond to this bandwidth demand, high speed systems are now being built with optical layers (optical fibre or planar waveguide) incorporated in replacement of the electrically-conducting metal. Indeed, light does not suffer from the same limitations as electricity.

Optical coupling devices are usually used to interconnect an optical layer of a PCB, or so-called optical circuit board (OCB), with an external optical device. In order to ensure efficient transfer of light through the optical coupling device, a very precise positioning of the latter along a vertical direction with respect to the circuit board is necessary. To this effect, the coupling device may have Z-reference parts which are placed with respect to precisely located Z-references of the circuit board. Then, a fixation part of the optical coupling device is glued to a fixation surface of the optical circuit board.

However, among optical circuit boards, there might be a large dispersion as to the location of the fixation surface with respect to the Z-reference. This is because the part of the optical circuit board which comprises the fixation surface is not manufactured with such a precise process as the Z-reference itself, in order mainly to reduce the cost of the optical circuit board. To cope with this problem, a solution would be to systematically use the amount of glue corresponding to the worst possible case, i.e. where the distance of the fixation surface to the fixation part of the optical coupling device would be maximal.

In such case, a correct fixation would be provided in such worst cases. However, in better cases, where the distance of the fixation surface to the fixation part of the optical coupling device is not so high, excess glue may spread. This is a problem since it may spread in a region intended to receive other devices, such as connector housings, and thus cause misconnections. It may even spread up to the region where optical signals transfer between the optical circuit board and the optical paths of the optical coupling device. In such case, the whole board may be unusable.

It is therefore required to improve the fixation of the optical coupling devices to the optical circuit boards to the expense of the optical signal transfer efficiency.

### SUMMARY OF THE INVENTION

An optical coupling device is provided for an optical communication system. The optical coupling device comprises optical paths extending between a first optical interface and a second optical interface. The second optical interface is to be optically coupled to a second optical device. The first optical interface is to be optically coupled to a first optical device. This first optical device has a Z-reference.

The optical coupling device further comprises a Z-reference part. It co-operates with the Z-reference of the first optical device, to define the location of the first optical interface with respect to said Z-reference along a direction.

The optical coupling device has a first fixation part, extending at a first height along said direction.

The optical coupling device has a second fixation part, extending at a second height along said direction. The second height is greater than said first height.

Either the first or second fixation part will be glued to the first optical device.

With these features, a correct fixation is ensured for any optical circuit board within the dispersion range of the height of the fixation surface, using a minimal amount of glue.

In some embodiments, one might also use one or more of the features as defined in the claims.

### BRIEF DESCRIPTION OF THE DRAWINGS

Other characteristics and advantages of the invention will readily appear from the following description of one of its embodiments, provided as a non-limitative example, and of the accompanying drawings.

On the drawings:

FIG. 1 is a partial perspective top view of an optical system,

FIG. 2 is perspective view of the bottom face of an optical coupling device,

FIG. 3 is a partial sectional view along line III-III of FIG. 1 for a first circuit board,

FIG. 4 is a view similar to FIG. 3 for a second circuit board,

FIG. 5 is a top view of the system of FIG. 1, and

FIG. 6 is a flow chart of an assembly process.

On the different Figures, the same reference signs designate like or similar elements.

### DETAILED DESCRIPTION

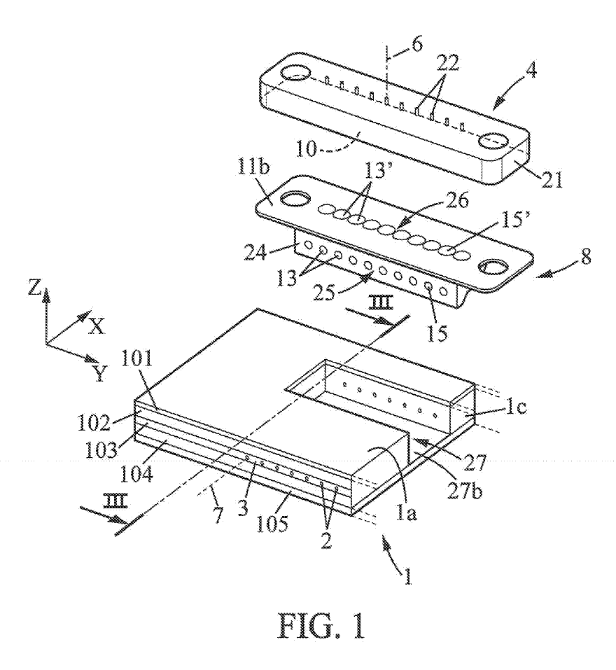

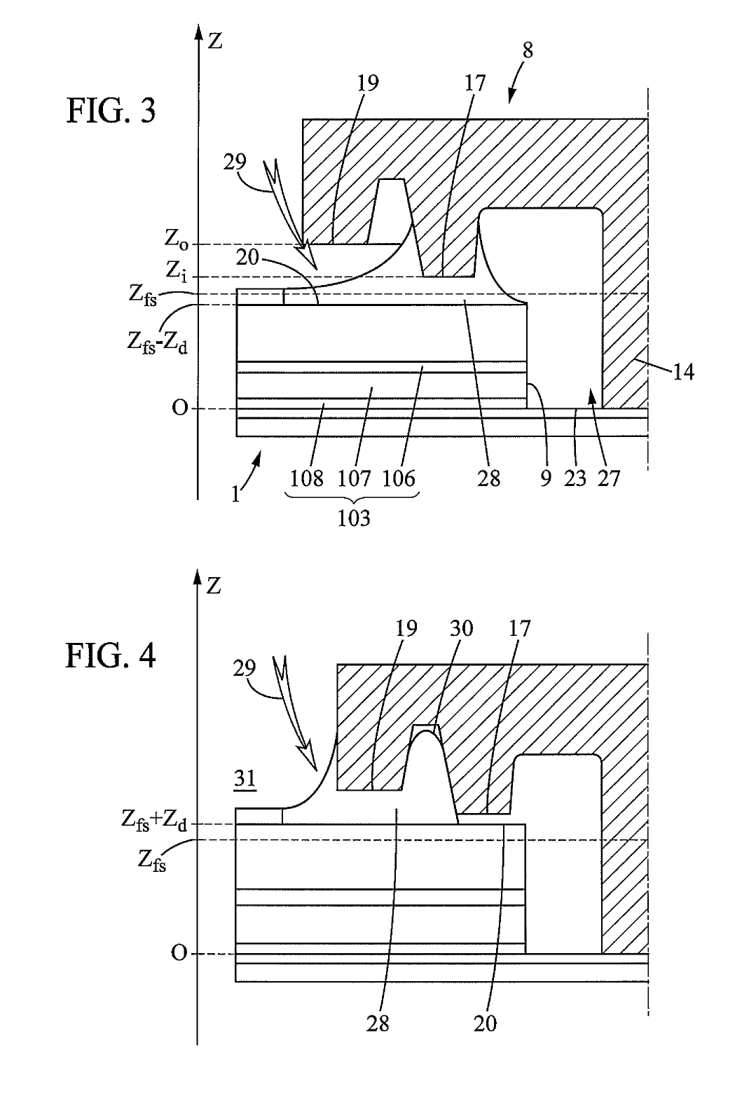

FIG. 1 partially shows a hybrid or full optical PCB for example a backplane, which is a layer stack comprising a plurality of layers. In particular, this layer stack 1 comprises, from top to bottom, a copper layer 101, a pre-preg layer 102, an optical layer 103, and further copper 104 and pre-preg 105 layers. The optical layer 103 itself comprises a first top cladding layer 106, a second transmission optical layer 107 below the first top cladding layer 106, and a third bottom cladding layer 108 below the second transmission optical layer 107 (see FIG. 3).

The terms “top”, “bottom”, “up”, “down” or the like are given in reference to the direction Z, normal to the top surface 1a of the PCB, and pointing toward a mating optical device 4 to be optically coupled to the PCB. The top surface of the PCB extends parallel to an X-Y plane, with X and Y being artificially defined. For example, X corresponds to the direction of propagation of light in the layer 107 and Y to the direction transverse thereto.

The optical layer 107 of the layer stack 1 is made of a plurality of tubes 2 integrated or embedded in a body 3 having a lower refractive index than the tubes 2. Thus, the tubes 2 and the body 3 constitute respectively the cores and the cladding of waveguides. Embedded waveguides may be polymer waveguides, glass sheet waveguides or waveguides obtained by embedded fibre technology, or the like.

It will be understood that a part of the PCB is removed from FIG. 1 to ease representation, and that what appears as a face 1c is in reality not a face but is internal to the PCB 1.

As can be seen on FIG. 1, a cut-out 27 is formed in the PCB 1. In particular, the cut-out 27 is shaped with a very simple form of a right parallelepiped. The cut-out is defined by straight walls. The cut-out can also have a plane bottom 27b, as shown.

The wall where the tubes 2 end at the cut-out defines an optical interface of the PCB. Namely, all cores 2 end at the cut-out 27 to define the optical interface 9 of the PCB (FIG. 3). This optical interface 9 comprises discrete light transmission regions arranged as an array. The spacing of transmission regions along the direction Y might be constant or not, depending on the requirements. For example, in the present drawing, the spacing between neighbour transmission regions is set constant to 250 μm.

Optical signals, transferred to or from a mating optical device 4, such as an optical device or opto-electrical device or an other PCB, are provided over a first optical path 6 to/from the cores 2 of the layer stack 1, which core 2 provides a second optical path 7 for the optical signal parallel to the X-Y plane. In the present example, the optical device 4 can for example comprise a mechanical-transfer ferrule (“MT-ferrule”) comprising a high precision sleeve 21 in which ends of optical fibers 22 extend in precisely defined relative locations. The mating optical device 4 thus has an optical interface 10 defined as the set of optic fibre ends directed toward the PCB. In the present drawing, this interface extends parallel to the X-Y plane.

The optical interface 10 of the mating connector has the same number of transmission regions as the optical interface 9 of the PCB. Each transmission region of the optical interface 10 of the mating optical device corresponds to a respective transmission region of the optical interface 9 of the PCB. This means that transmission regions are associated two by two and that light normally exited through the transmission region of one of the interfaces is to be transmitted to the corresponding transmission region of the other interface.

The printed circuit board 1 further comprises a Z-reference. The Z-reference is a part of the printed circuit board the location of which along the Z direction is precisely known with respect to the optical interface 9. For example, it corresponds to the bottom of the bottom cladding layer (or rather to the coinciding top 23 (see FIG. 3) of the underlying copper layer 104). However, other locations are possible, such as the top of the top cladding layer, for example.

In order to achieve an optimal optical coupling between the first and second optical paths, that are perpendicular to each other for the optical system here, an optical coupling device 8 is provided for alignment purposes. In the present example, the optical coupling device 8 is provided as a single unitary component, although this is not necessarily always the case.

The coupling device 8 is, for example, a unitary piece manufactured by moulding a translucent suitable material. The optical coupling device 8 comprises a first face 24 defining a first optical interface 25 which is to be put in optical coupling with the optical interface 9 of the PCB. The first optical interface 25 has transmission regions 13 which are to be placed opposite in free space (sometimes through a translucent coupling medium such as air or a suitable glue) a corresponding transmission region of the interface of the PCB. Hence, the arrangement of the first optical interface 25 directly derives from that 9 of the printed circuit board, and it will not be described in further details here.

The optical coupling device 8 comprises a second face 11b which, in the present case, extends normal to the first face, i.e. extends parallel to the X-Y plane. It defines a second optical interface 26 which is to be put in optical coupling with the optical interface of the mating optical device 4. The second optical interface 26 has transmission regions 13′ which are to be placed opposite (sometimes through a translucent coupling medium such as air or a suitable glue) a corresponding transmission region of the interface of the mating optical device 4. Hence, the arrangement of the second optical interface 26 directly derives from that of the mating optical device 4, and it will not be described in further details here.

An optical path is defined between the first and second interfaces 25, 26 of the coupling device 8. Namely, diverging light entering the coupling device 8 at its first interface 25, coming from the interface of the printed circuit board 1 will be propagated through the coupling device 8 to the second interface 26 as a substantially collimated light beam, and will be focussed into the interface of the mating optical device 4. Light propagates in the opposite direction in a similar way.

In particular, each transmission region of each interface of the coupling device 8 can be provided with a light beam forming structure 15, 15′ such as a lens. The lenses 15 optimise the optical coupling of the optical signals of the cores 2 to/from the coupling device 8. The lenses 15′ optimise the optical coupling of the optical signals of the ferrule 4 to/from the coupling device 8.

Since lenses 15 and 15′ focus the optical signals at the entry of each core 2 and respectively at the entry of each optical fibre 22, the manufacturing tolerance of the coupling device 8, the ferrule 4 and the layer stack 1 are increased in comparison with an optical coupling system without lenses.

As shown in the present example, the lenses 15, 15′ may form an integral part of the coupling device 8. They are located at the first and second interfaces. They could be of the Fresnel-type or of the aspheric type, for example. It will be appreciated that, for each interface, all lenses of the interface could be performed identical.

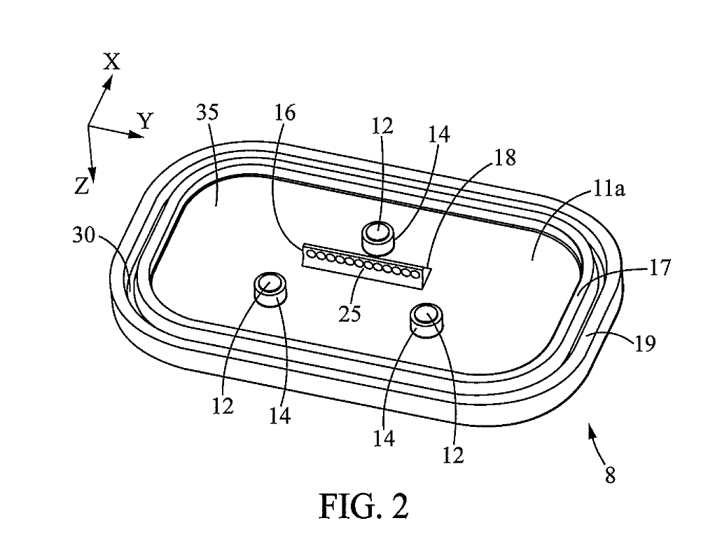

FIG. 2 now shows in more details the bottom face of the coupling device 8. The coupling device 8 is provided as a thin plate having a first (bottom) face 11a and an opposite parallel second (top) face 11b (FIG. 1). A body 16 projects from the bottom face 11a downwards, rather centrally. This body carries the optical interface 25, as well as a mirror 18 used to deflect light from the X direction to the Z direction.

Further, the optical coupling device 8 is provided with Z-reference parts 12. Z-reference parts 12 are parts of the optical coupling device 8, the location of which along the direction Z is precisely known with respect to the first optical interface 25. This accuracy of the positioning in Z direction can be achieved during the manufacturing of the coupling device via e.g. a micro-moulding process. These parts are for example surfaces extending parallel to the X-Y surface. For example, three such parts can be provided as three feet 14 which project from the face 11a. These feet can be provided unaligned, and of the same length, so that the three Z-reference parts 12 precisely define a plane.

The optical coupling device 8 further comprises fixation parts. These fixation parts are used to fix the optical coupling device 8 to the printed circuit board 1. The fixation parts are for example provided at the periphery of the optical coupling device 8. For example, a first fixation part is a peripheral ridge 17 which extends continuously around the whole periphery of the device. Further, a second fixation part is provided as a second peripheral ridge 19, which extends continuously around the whole periphery of the device. The second peripheral ridge also surrounds the first peripheral ridge 17. Thus, the second peripheral ridge 19 is an outer fixation part, while the first peripheral ridge 17 is an inner fixation part. Hence, the first peripheral ridge 17 is located between the second peripheral ridge 19 and the body 16.

The fixation parts 17, 19 project from the face 11a of the optical coupling device.

As can be seen in FIG. 3, the optical coupling device will be placed over the cut-out 27 of the printed circuit board 1 so that the Z-reference parts 12 will cooperate with the Z-reference of the printed circuit board, so as to precisely define the position of the optical coupling device 8 with respect to the Z-reference of the printed circuit board along the Z axis. For example, the Z-reference parts 12 are simply laid on the Z-reference 23 of the printed circuit board 1. However, other ways to precisely define the location of the optical coupling device 8 along the Z direction with respect to a Z-reference of the printed circuit board exist.

In theory, in this position, the optical coupling device and the printed circuit board are so positioned with respect to one another along the direction Z, that an efficient optical coupling occurs between the interface 9 (out of the plane of FIG. 3) of the printed circuit board and the optical interface 25 of the optical coupling device (not visible on this drawing). This is due to the precisely known relative positioning along the direction Z of:
the interface 9 of the circuit board with the Z-reference 23 by construction of the circuit board,
the Z-reference 23 with the Z-reference part 12 of the optical coupling device 8 by co-operation, and
the Z-reference part 12 with the optical interface 25, by construction of the coupling device.

If necessary, X-Y reference means (not shown) are used to carefully place the coupling device with respect to the circuit board in the X-Y plane.

The Z-reference 23 of the printed circuit board defines the origin O of the Z axis. As mentioned before, the Z axis is oriented in a direction out of the main plane of the circuit board, toward the mating optical device 4. This is the direction of light exiting/entering the circuit board. In the present case, the height of the Z-reference parts of the optical coupling device is 0.

The fixation surface 20 of the printed circuit board is used to cooperate with the fixation parts 17, 18 of the optical coupling device 8 to fix the optical coupling device 8 to the circuit board 1. For example, the fixation surface 20 corresponds to the accessible top face 1a of the printed circuit board, either being for example the top face of the copper layer 101 or that of the pre-peg layer 102 if the copper layer 101 has been removed in this area. The fixation surface is at a height Z_{fs}, measured along the Z direction from the origin O. The height Z_{fs} is the nominal height which is known from the stacking of the circuit board 1. However, due to inevitable dispersion linked to the manufacturing process of the OCB, the real height of the fixation surface will vary, from one printed circuit board to one another between Z_{fs}−Z_{d} (FIG. 3) and Z_{fs}+Z_{d} (FIG. 4).

When the optical coupling device 8 is placed on the printed circuit board, the inner fixation part 17 extends at a height Zᵢ from the origin O. The outer fixation part extends at a height Zₒ. These heights are the height of the bottom surface, opposed to the fixation surface 20, of the respective fixation parts 17, 18. Both Zᵢ and Zₒ are strictly greater than Z_{fs}+Z_{d}, to enable the Z-reference part 12 to lay on the Z-reference 23 of the circuit board.

Further, the heights Zᵢ and Zₒ differ from one another. In the present embodiment, they differ by at least 50 micrometers, although this difference will depend on the precision of the manufacturing process of the circuit boards, namely of the value of Z_{d}. Zᵢ and Zₒ could differ by about Z_{d}.

In particular, the first (inner) fixation part 17 is closer to the fixation surface 20 than the second (outer) fixation part 19. In other words, the height Zₒ is greater than the height Zᵢ.

FIG. 3 represents a worst-case scenario. I.e., on FIG. 3, the fixation parts are as far away as possible from the fixation surface 20. The volume of glue 28 to be used to fix the optical coupling device 8 to the optical circuit board is always decided before hand, based on the geometry of FIG. 3, whatever the real height of the fixation surface is for the actual circuit board. Once the optical coupling device is positioned, glue is made to flow from the periphery of the coupling device, for example using a syringe along the arrow 29. Glue 28 will flow between the bottom surface of the first fixation part 17 and the fixation surface 20 of the circuit board, directly opposed thereto. Fixation will occur between these two surfaces.

FIG. 4 represents a scenario where the fixation surface 20 is at a height Z_{fs}+Z_{d}. A huge majority of the printed circuit boards will be between the cases of FIG. 3 and FIG. 4. The height Zᵢ is chosen to be very close to Z_{fs}+Z_{d}. In particular, Zᵢ is chosen so close to Z_{fs}+Z_{d} that glue is prohibited from flowing in the free space defined between the first fixation part 17 and the surface 20 of the circuit board. The first fixation part 17 thus acts as a glue barrier. This action is provided without any contact between the surface of the fixation part 17 and the fixation surface 20, because such a contact would prevent any proper Z alignment of the optical system. The height difference Zᵢ−(Z_{fs}+Z_{d}) can be provided based on the characteristics of the glue itself (for instance its thixotropic property). The free space between the first fixation part 17 and the surface 20 of the circuit board will thus act as a capillary trap for the glue.

As can also be seen on FIG. 4, in this scenario, the outer fixation part 19 will take over the role played by the inner fixation part 17 in the case of FIG. 3. The glue will mainly extend between the outer fixation part 19 and the fixation surface 20 of the printed circuit board. The volume of used glue is equal to that of FIG. 3.

If necessary, the coupling device can be provided with a recess 30 located between the first and second fixation parts. In the present example where the first and second fixation parts are peripheral ridges running all along the periphery of the coupling device, the recess 30 can be provided as a groove also running all along the periphery of the coupling device (see FIG. 1). The recess will absorb excess glue flowed between the coupling device and the circuit board in this scenario. Hence, glue will be prevented from flowing back outward. The space 31 surrounding the optical coupling device 8 will therefore be substantially free of glue, and can receive a connector housing or any other suitable device, if necessary.

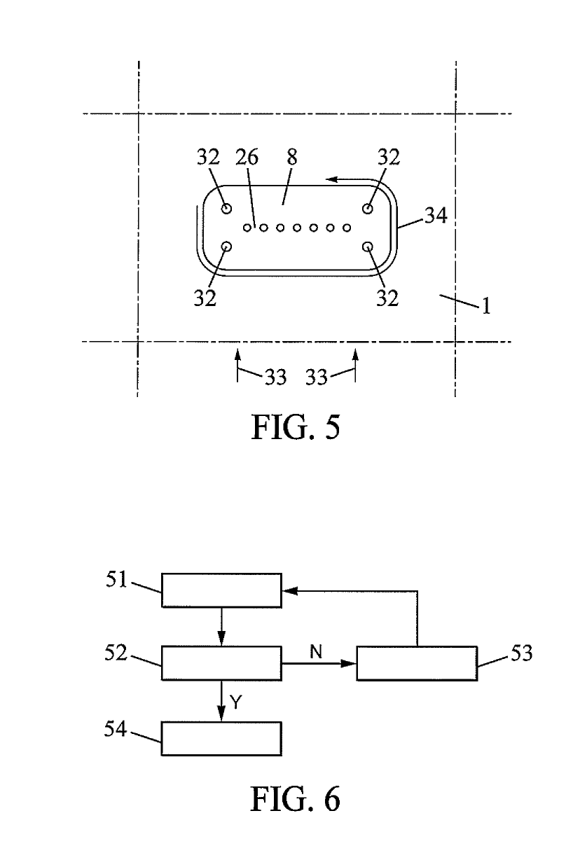

Turning now to FIGS. 5 and 6, a method of assembly will be schematically described. At step 51, the optical coupling device 8 will be pre-assembled to the printed circuit board 1. For example, it will be glued in position by using few (3-4) glue spots 32 provided beforehand on the circuit board or the coupling device. Then, a test of the accuracy of the positioning is performed at step 52. Such a test is for example an active step by which known light rays 33 are made to pass in one or more of the optical cores of the circuit board 1, and output light at the second interface 26 of the coupling device 8 is detected by any suitable way. In step 52, it is determined whether detected light is suitable, compared to what is expected. Other kinds of test are possible. If the result of this test is negative (arrow N on FIG. 6), the coupling device 8 can be removed at step 53, and it will be possible to replace it by another one or try to place it in a better position with respect to the printed circuit board. Some maintenance might be requested on the automated pick-and-place machine. Thus, the optical circuit board need not be discarded because of this wrong connection. After a suitable process change, the assembly method moves back to step 51.

If the result of this test is positive (arrow Y on FIG. 6), permanent fixation of the coupling device to the circuit board is performed at step 54. In particular, the pre-determined volume of glue is dispensed continuously all around the periphery of the pre-positioned coupling device, using a syringe, for example following the movement shown by the arrow 34 on FIG. 5. The glue can therefore act as a seal, preventing ingress of material in the cut-out 27.

A set of optical systems can thus be provided, with reliable fixation, where the optical coupling devices are identical, and where the height of the fixation surface may vary between Z_{fs}−Z_{d} and Z_{fs}+Z_{d}.

Although the invention was presented with a right-angled optical coupling device 8, it could be applied to other kinds of optical coupling devices, such as ones with straight optical paths along the direction Z, for example.

1. An optical coupling device for an optical communication system, said optical coupling device comprising:
at least one optical path extending between a first optical interface to be optically coupled to a first optical device having a Z-reference, and a second optical interface to be optically coupled to a second optical device,
a Z-reference part, adapted to co-operate with said Z-reference of the first optical device, to define the location of the first optical interface with respect to said Z-reference along a direction,
at least one first fixation part, extending at a first height along said direction, adapted to be glued to first optical devices,
at least one second fixation part, extending at a second height along said direction, adapted to be glued to first optical devices,
wherein said second height is greater than said first height.

2. Optical coupling device of claim 1, wherein the first fixation part is located between the second fixation part and the optical path.

3. Optical coupling device of claim 1, further comprising a recess between said first and second fixation parts.

4. Optical coupling device of claim 1, wherein the first fixation part comprises a peripheral ridge extending all along a periphery of the optical coupling device.

5. Optical coupling device of claim 1, wherein the second fixation part comprises a peripheral ridge extending all along a periphery of the optical coupling device.

6. Optical coupling device of claim 3, wherein said recess comprises a peripheral groove extending all along a periphery of the optical coupling device.

7. An optical coupling device for an optical communication system, said optical coupling device comprising:
at least one optical path extending between a first optical interface to be optically coupled to a first optical device having a Z-reference, and a second optical interface to be optically coupled to a second optical device,
a Z-reference part, adapted to co-operate with said Z-reference of the first optical device, to define the location of the first optical interface with respect to said Z-reference along a direction,
at least one first fixation part, comprising a peripheral ridge extending all along a periphery of the optical coupling device, adapted to be glued to first optical devices,
at least one second fixation part, comprising a peripheral ridge extending all along a periphery of the optical coupling device, outer from the first fixation part, adapted to be glued to first optical devices.

8. Optical coupling device of claim 7, further comprising a peripheral groove extending all along a periphery of the optical coupling device between said first and second fixation parts.

9. Optical coupling device according of claim 7, wherein the first fixation part extends at a first height along said direction, wherein the second fixation part, extends at a second height along said direction,
wherein said second height is greater than said first height.

10. An optical coupling device for an optical communication system, said optical coupling device comprising:
at least one optical path extending between a first optical interface to be optically coupled to a first optical device having a Z-reference, and a second optical interface to be optically coupled to a second optical device,
a Z-reference part, adapted to co-operate with said Z-reference of the first optical device, to define the location of the first optical interface with respect to said Z-reference along a direction,
at least one first fixation part, comprising a peripheral ridge extending at a first height along said direction all along a periphery of the optical coupling device, adapted to be glued to first optical devices,
at least one second fixation part, comprising a peripheral ridge extending at a second height along said direction all along a periphery of the optical coupling device, outer from the first fixation part, adapted to be glued to first optical devices,
a peripheral groove extending all along a periphery of the optical coupling device between said first and second fixation parts,
wherein said second height is greater than said first height.

11. Optical coupling device according of claim 10, further comprising a plate having opposed first and second faces normal to said direction, wherein said optical path at least partly projects from said first face, wherein the Z-reference part, the first and second fixation parts project from said first face.

12. An optical system comprising the optical coupling device of claim 10, and an optical circuit board, said optical circuit board having:
a Z-reference, adapted to co-operate with said Z-reference part of the optical coupling device,
an optical interface optically coupled to a first optical interface of the optical coupling device,
a fixation surface glued to at least one of the first and second fixation parts of the optical coupling device.

13. The optical system of claim 12, wherein a distance between the first fixation part and the fixation surface of the optical circuit board is comprised between 20 and 50 micrometers, wherein glue mainly extends between the second fixation part and the fixation surface of the optical circuit board.

14. The optical system of claim 12, wherein a distance between the first fixation part and the fixation surface of the optical circuit board is comprised between 50 and 150 micrometers, wherein glue mainly extends between the first fixation part and the fixation surface of the optical circuit board.

15. The optical system according to claim 12 comprising thixotropic glue.

16. The optical system according to claim 12, wherein glue is provided all along a periphery of said optical coupling device.

17. A set of optical systems comprising:
at least one first optical system of claim 12, wherein the fixation surface of the optical circuit board extends at a first distance from the Z-reference of the optical circuit board along said direction,
at least one second optical system according to any of claims 12 to 16, wherein the fixation surface of the optical circuit board extends at a second distance from the Z-reference of the optical circuit board along said direction,
wherein the second distance is greater than the first distance,
wherein the optical coupling devices of the first and second optical systems are identical.

18. A method of assembly of an optical system comprising:
a) providing an optical circuit board having a Z-reference, an optical interface, and a fixation surface,
b) providing an optical coupling device comprising:
at least one optical path extending between a first optical interface and a second optical interface to be optically coupled to a second optical device,
a Z-reference part, adapted to cooperate with said Z-reference of the optical circuit board to define the location of the first optical interface with respect to said Z-reference along a direction,
at least one first fixation part, extending at a first height along said direction,
at least one second fixation part, extending at a second height along said direction, wherein said second height is greater than said first height,
c) gluing one of the first and second fixation parts to the optical circuit board with the Z-reference and the Z-reference part co-operating with one another, so that the optical interface of the optical circuit board be optically coupled to the first optical interface of the optical coupling device.

19. The method of claim 18, wherein c) gluing comprises:
c1) pre-gluing the optical coupling device on the optical circuit board in a respective location,
c2) providing a result of a test of an accuracy of said location, and
c3) if said result is positive, permanently gluing the optical coupling device on the optical circuit board in said respective location.

20. The method of claim 18, wherein c) gluing comprises continuously dispensing glue all along a periphery of said optical coupling device.

21. Optical coupling device of claim 1, further comprising a plate having opposed first and second faces normal to said direction, wherein said optical path at least partly projects from said first face, wherein the Z-reference part, the first and second fixation parts project from said first face.

22. An optical system comprising: the optical coupling device of claim 1, and an optical circuit board, said optical circuit board having:
a Z-reference, adapted to co-operate with said Z-reference part of the optical coupling device,
an optical interface optically coupled to a first optical interface of the optical coupling device,
a fixation surface glued to at least one of the first and second fixation parts of the optical coupling device.

23. The optical system of claim 22, wherein a distance between the first fixation part and the fixation surface of the optical circuit board is comprised between 20 and 50 micrometers, wherein glue mainly extends between the second fixation part and the fixation surface of the optical circuit board.

24. The optical system of claim 22, wherein a distance between the first fixation part and the fixation surface of the optical circuit board is comprised between 50 and 150 micrometers, wherein glue mainly extends between the first fixation part and the fixation surface of the optical circuit board.

25. The optical system of claim 22 comprising thixotropic glue.

26. The optical system of claim 22, wherein glue is provided all along a periphery of said optical coupling device.

27. A set of optical systems comprising:
at least one first optical system of claim 22, wherein the fixation surface of the optical circuit board extends at a first distance from the Z-reference of the optical circuit board along said direction,
at least one second optical system according to any of claims 12 to 16, wherein the fixation surface of the optical circuit board extends at a second distance from the Z-reference of the optical circuit board along said direction,
wherein the second distance is greater than the first distance,
wherein the optical coupling devices of the first and second optical systems are identical.
